(19) United States
(12) Patent Application Publication
(10) Pub. No.: US 2011/0027001 A1
(43) Pub. Date: Feb. 3, 2011

(54) WRITING INSTRUMENT FITTED WITH A FILING SLEEVE, WHICH ACTS AS A PLUNGING MECHANISM AND HAS AN ABRASIVE SURFACE TO BE USED FOR NAIL FILING

(76) Inventor: John O'HERN, Hoboken, NJ (US)

Correspondence Address: FROMMER LAWRENCE & HAUG, 745 FIFTH AVENUE- 10TH FL., NEW YORK, NY, 10151, US

(21) Appl. No.: 12/533,510

(22) Filed: Jul. 31, 2009

(51) Int. Cl. B43K 29/00; B23P 17/04

(52) U.S. Cl. 401/195; 29/592

(57) ABSTRACT

A writing instrument is provided comprising a filing sleeve on which is an abrasive surface used for nail filing. The filing sleeve, when installed, acts as a plunging mechanism for the pen and provides the writing instrument with a nail shaping surface along the length of the filing sleeve. The external surface of the filing sleeve has one or more grades of abrasiveness to be used for nail filing and may be a variety of configurations, including circular or three, four, or five sided.

### FIELD OF THE INVENTION

The present invention relates to a filing sleeve, and more particularly, to a filing sleeve installed on a writing instrument. On the filing sleeve are located one or more abrasive surfaces, which are adapted to shape fingernails. Additionally, the filing sleeve acts as the plunging mechanism for the writing instrument. That is, the filing sleeve is fitted on the end of the writing instrument that is opposite the writing end of the instrument and the filing sleeve is part of an extension and retraction system for positioning the writing point in either a first position where the writing point extends beyond the distal end of the writing instrument or in a second position where the writing point is retained within the housing of the writing instrument.

### BACKGROUND DISCUSSION

There are various implements that are used for shaping finger nails, many of which are simply nail files and have no other useful purpose. As such, those devices are simply carried and used by themselves. On the other hand, there are other devices that have been disclosed and which are combination devices such that the device not only comprises a nail file but may also have an additional purpose. Such combination devices are of an added convenience to the user, particularly if the other use of the device is also a use that would normally entail a device that is carried on one's person such as, for example, in a woman's purse.

Accordingly, such combination devices can be employed to combine two or more functions in a single device. One of such combination device combines the functions of a writing instrument while also providing the convenience and utility of being usable for shaping nails, that is, of being used as a nail file.

One such device that is a combination of a writing instrument and a nail shaping device is U.S. Pat. No. 6,572,299 to Brennan (hereinafter, merely “Brennan”). Brennan discloses a writing instrument in which an abrasive strip or strips are located in slots that are formed along the main body of the writing instrument. There are at least three drawbacks to the slotted design of Brennan. First, in terms of production, the slotting process is complicated and costly. Manufacturing a pen generally requires only a one or two pressure injection molds. The Brennan slotted pen requires multiple molds and substantial labor to assemble the pen and insert the abrasive into the slots. The Brennan slotted pen therefore is particularly unsuited for modern industrial processes. See Sherts. Indeed, the complex and expensive process results in a high-cost item for a low-cost market. Consequently, the Brennan slotted pen has limited industrial application because it has a remote chance of ever reaching the market. Second, the Brennan slotted pen is not user friendly to one who wants to file her nails. Specifically, the abrasive on the Brennan slotted pen has limited utility because the narrow slot results in an abrasive of limited surface area. In addition, the slot results in the abrasive surface sitting in a recessed portion on the pen. In other words, the abrasive lies below the surface of the main body of the pen. Consequently, one who wants to file her nails must extend her nail into the narrow slotted area. Finally, the writing tip of the Brennan writing instrument is in a fixed position meaning that the writing tip is always exposed. Thus, with the writing tip permanently exposed, the Brennan writing instrument will permanently stain or mark one's bag, purse, or pocket when traveling with the item. Also, with the writing tip permanently exposed, when the user files her nails she will likely mark or stain herself or her clothes.

Another example of a device that combines the functions of a writing instrument and a nail shaping device is shown and described in U.S. Pat. No. 5,090,427 of Sherts (hereinafter, merely “Sherts”). The Sherts patent discloses a writing instrument that has a cap on which is located an abrasive strip that can be used for shaping of fingernails. The primary disadvantage of the Sherts device is that the abrasive is located on a cap which is not secured to the writing instrument. Users regularly lose pen caps. Also, the cap can become disengaged, or loose, from the main body of the instrument when one is filing her nails. Thus, the user will have a difficult time filing her nails if the cap moves during the filing process. And it will be more difficult to file one's nails if the cap is separated from the body of the pen. Furthermore, the overall length and width of the strip of abrasive material, being confined to the cap of the writing instrument, is limited and, as such, the user cannot get a full stroke or full effective use of the nail shaping function. Moreover, the limited space on the cap results in a device which can provide only one grade of abrasive for the user. Finally, if the cap is lost, the user is left with a pen with a writing tip that is always exposed. Thus, one could not put a capless writing instrument in one's bag, purse, or pocket without permanently staining or marking the items. Also, with the writing tip permanently exposed, when the user files her nails she will likely mark or stain herself or her clothes.

In addition to the combination devices of the type discussed above, there also has been disclosed a pen on to which is affixed a pocket clip attachment. U.S. Pat. No. 1,478,049 of Nelson (hereinafter, merely “Nelson”). An abrasive surface, to be used for nail care purposes, is embedded on the pocket clip in Nelson. Nelson, however, has similar drawbacks and limitations as Sherts. Indeed, like the Sherts cap, the Nelson pocket clip provides limited length and width on which to place an abrasive surface. The Nelson pocket clip also allows for only one grade of abrasive to be made available to the user. And the writing tip of the Nelson writing instrument is in a fixed position meaning that the writing tip is always exposed. Thus, one cannot put the Nelson writing instrument in one's bag, purse, or pocket without permanently marking or staining the items. Also, with the writing tip permanently exposed, when the user files her nails she will likely mark or stain herself or her clothes.

Other examples of such combination devices that have also been disclosed include Design Pat. No. 257,181 to Brown and U.S. Pat. No. 2,841,156 of Herald, both of which rely upon a pocket clip as the location for the abrasive surface to be used for nail care. Brown and Herald suffer from the similar drawbacks of previously discussed combination devices. By relying on the pocket clip, the Brown and Herald devices offer a surface areas which are also severely limited in length and width for the abrasive. The pocket clip of Brown and Herald also allow for only one grade of abrasive because they also rely on the clip of a pen for the location of the abrasive strip and thus suffer from the same drawbacks as the previously discussed combination devices. And the writing tip of the Brown and Herald writing instruments is always exposed meaning that one cannot place these in one's bag, purse, or pocket without permanently staining or marking either. Also, with the writing tip permanently exposed, when the user files her nails she will likely mark or stain herself or her clothes.

The problem or deficiency of the aforedescribed prior art devices is a product of the limited length and width of the abrasive strip that results from the utilization of a clip, cap, slot, or other relatively small component of the writing instrument. These devices cannot physically provide more than one relatively short and narrow strip of such material. Thus, with any of these combination devices, it would not be practical to include more than one strip of the abrasive material, such as would be advantageous of a user desiring more the one abrasive strip so as to have differing grades of abrasiveness. For example, if a user were to desire a device having one strip of a material that is a coarse abrasive and a second strip of a material with a finer abrasiveness on the same writing instrument.

It would therefore be advantageous to have a writing instrument which has a longer, wider, and more accessible surface or strip of abrasive material, but additionally, can have the capability, dimensionally, to provide more than one abrasive surface with differing grades of abrasive materials so that the user can have additional flexibility and functionality in utilizing the nail shaping function while not detracting from the writing capability of the writing instrument.

As a result of the problem or deficiency of the aforedescribed prior art devices relative to the fixed position of the writing tip, it would be advantageous to have a combination device which allows for the writing tip to move from a position where it is outside of the body of the writing instrument to enclosed by the body of the writing instrument. Thus, when the writing tip is enclosed in the body of the writing instrument the user can carry the device in one's pocket, purse or bag without marking or staining the items. And when the writing tip is enclosed in the body of the writing instrument, the user can file her nails without concern of marking or staining herself of her clothes with the writing tip.

Writing instruments and nail care instruments are generally inexpensive items. Therefore, it is advantageous to have a device that can be manufactured easily and inexpensively. A device such as the Brennan writing instrument has little industrial applicability because the difficulty in manufacturing the product will result in a high cost item. And combination devices as those described herein are low cost items. A writing instrument with a filing sleeve, which acts as the instrument's plunging mechanism, has broad industrial application because it can be manufactured easily and inexpensively. Thus, it can easily reach the low cost market for devices which combine writing instruments and nail care items.

### SUMMARY OF THE INVENTION

The present invention provides a filing sleeve with a nail shaping function that overcomes the problems and deficiencies of the aforedescribed prior art combination devices. Thus, in accordance with the present invention, a combination filing sleeve and writing instrument is provided in which the filing sleeve has an abrasive surface and the writing instrument comprises a main body on to which the filing sleeve is installed. The filing sleeve, when installed, provides the writing instrument with both a nail shaping function along the length of the tubular body and acts as the plunging mechanism for the writing instrument. The abrasive surface, which is used for nail filing, can be extended in length over those uses where the abrasive strip is oriented on the clip, cap, or slot of the writing instrument.

The particular writing instrument may be, for example, a pencil, ink pen, ball point pen, or a fountain pen, or the like and preferably a ball point. As is normal with such instruments, the writing substance is located within the main body of the instrument and, as stated, can be either pencil lead, a normal liquid ink or an ink cartridge for a ball point pen. The exterior surface of the body of the writing instrument can also be of a variety of configurations or shapes, including square, rectangular, oval, round or other geometrical or non-geometrical shapes.

The present invention provides a writing instrument provided with filing sleeve, which acts as a plunging mechanism. The plunging mechanism comprises a plunging member fit into an opposite end of the writing end of the writing instrument and the filing sleeve triggers an extension and retraction system for positioning the writing point in either a first position where the writing point extends beyond the distal end of the writing instrument or in a second position where the writing point is retained within the housing of the writing instrument.

In one embodiment of the present invention, the exterior surface of the filing sleeve is four sided and on to each side an abrasive surface is affixed. The exterior surface of the filing sleeve, however, may be any shape, including circular, three sided, and five sided, and may have an abrasive surface located on any, some, or all of the surfaces. The exterior surface of the main body and the exterior surface of the filing sleeve may be of the same shape or dissimilar shapes.

In the case of a square external configuration of the filing sleeve, at least two abrasive surfaces, which are used for nail filing, are located on the sleeve. Alternatively, two contiguous sides may have one grade of abrasive surface and the remaining sides will have another grade of abrasive material. With other external surface configurations of the filing sleeve, the multiple or plurality of such abrasive surfaces may be contiguous to each other or may be separated by some non-abrasive surface. Also, in some instances, all sides of the filing sleeve will be covered with a single grade of abrasive surface.

As is also preferred in the present invention, where two or more abrasive surfaces are located on the external surface of the filing sleeve, the individual surfaces may have differing grades of abrasiveness, that is, one of the surfaces may have a coarse abrasive material while the other surface may be comprised of a finer abrasive material so that the user can initially shape the fingernail with the coarser material and finish the shaping of the fingernail with the finer abrasive material.

The abrasive surface of the filing sleeve itself can be provided in the form of a strip that is affixed to the exterior surface of the exterior surface of the filing sleeve by means of an adhesive or can be actually molded into or pressed into the external plastic material of the filing sleeve and thus embedded into that external surface. As a further embodiment, the strip of abrasive material may be separately provided and placed into a special formed recess portion on the external surface thereof, and then further affixed thereto by an adhesive.

Thus, as explained, with the present invention, there is provided a filing sleeve for a writing instrument having an abrasive material used for nail filing located on the exterior surface and therefore can be considerably wider and longer in overall length of the abrasive surface as compared to device in which the abrasive material is applied to a limited area on the instrument such as the cap, clip, or a slot on a writing instrument.

In addition, with the additional external surface area that is therefore available on the present writing instrument, there can be provided a plurality of surfaces of the abrasive material and thereby give the user additional flexibility in being able to have a plurality of surfaces of abrasive material having differing grades of abrasiveness. The increased surface area and additional flexibility in grades of abrasiveness gives the user an improved nail filing and nail care experience.

An abrasive surface for nail filing will be attached to the filing sleeve, which acts as the plunging mechanism. The filing sleeve, while acting as the plunging mechanism, can accommodate one or more abrasive surfaces. The filing sleeve, while acting as a plunging mechanism, may be of any length, width, or shape. The plunging mechanism may also include a clip as described above. The writing instrument comprises a main body having an external surface, wherein said main body has a proximal end and a distal end having a writing point, a portion towards the distal end that a user grips when using the writing instrument for writing, and a portion towards the proximal end where a plunging mechanism may be connected. The plunging mechanism, which is the filing sleeve or a clip, may comprise an exterior surface and an interior surface that overlaps the exterior surface of the main body. An abrasive surface may be fixed to the exterior surface of the plunging mechanism.

In another embodiment, the present invention provides a writing instrument provided with a plunging mechanism on which is affixed a clip and on the clip is affixed an abrasive surface used for nail filing. The plunging mechanism may comprise a plunging member, on to which is affixed a clip, fit into an opposite end of the writing end of the writing instrument and an extension and refraction system for positioning the writing point in either a first position where the writing point extends beyond the distal end of the writing instrument or in a second position where the writing point is retained within the housing of the writing instrument.

Other features of the filing sleeve and writing instrument will become apparent in light of the following detailed description of a preferred embodiment thereof and as illustrated in the accompanying drawings.

### BRIEF DESCRIPTION OF THE DRAWINGS

FIG. 1 shows a perspective view of a writing instrument fitted with the filing sleeve in accordance with the present invention;

FIG. 2 shows a perspective view of a second embodiment of the writing instrument;

### DETAILED DESCRIPTION OF THE INVENTION

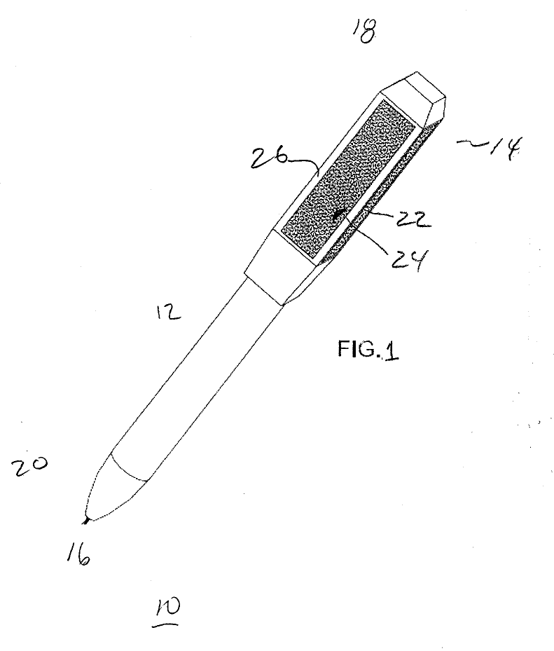

FIG. 1 shows a perspective view of a writing instrument 10 fitted with a filing sleeve 14 in accordance with the present invention. In the embodiment of FIG. 1, the writing instrument 10 comprises a main body 12 having a predetermined external surface having a circular configuration. In this embodiment, the writing instrument 10 comprises a filing sleeve 14 which acts as a plunging mechanism located on the writing instrument 10 in order to operate the device and to move the point 16 of the ball point cartridge contained within the main body 12 from an exposed position as shown in FIG. 1 to a refracted position. Accordingly, although a ball point pen embodiment is shown and described hereinafter with respect to FIG. 1, it will be seen that the writing instrument 10 may be any other type of similar writing instrument 10, including, but not limited to, fountain pen, a pencil, or other device.

As will also be referenced, the top end of the writing instrument 10 will be referred to as the proximal end 18 where the end of the writing instrument 10 that contacts the material for writing thereon, and where the point 16 is located will be referred to as the distal end 20. The distal end 20 narrows down in the direction of the point 16 and may become generally circular in cross section in order to be more convenient and comfortable for the user to properly grip the writing instrument 10.

The main body 12 of the writing instrument 10 has an exterior surface that can also be of a variety of configurations, including square, rectangular, oval, round or other geometrical or non-geometrical shapes.

As shown in FIG. 1, the filing sleeve 14 may be installed covering a portion of the main body 12 of the writing instrument 10. In one embodiment, the exterior surface of the filing sleeve 14 is square and the entire surface is abrasive. As shown in FIG. 1, the filing sleeve 14 is four sided and tapers at the two ends. However, the exterior surface of the filing sleeve 14 may be any shape, including circular, three sided, and five sided, and may have an abrasive surface located on any or all of the surfaces.

In another embodiment of the present invention, the exterior surface of the main body 12 and the exterior surface of the filing sleeve 14 may be of the same shape or dissimilar shapes. For example, the filing sleeve 14 may be four sided and the main body 12 may be round.

In one embodiment, each of the exterior sides of the filing sleeve 14 is abrasive. However, in the case of a square external configuration of the filing sleeve 14, two abrasive surfaces may be located on the sleeve 14. Two contiguous sides may have one grade of abrasive surface and the remaining two sides will have a different grade of abrasive material. In one embodiment there at least two abrasive surfaces 22, 24 formed on that exterior surface of the filing sleeve 14, and there may be a non-abrasive surface 26 located intermediate each of the abrasive strips 22, 24 to separate those strips for the convenience in using the writing instrument 10 for the shaping of the fingernails. Also, in some instances all of the filing sleeve 14 will be covered with a single grade of abrasive surface.

The actual material used for the abrasive surface of the filing sleeve 14 may be a material as is currently used in nail files and the like.

Where two or more abrasive surface are located on the external surface of the filing sleeve 14, the individual surfaces may have differing grades of abrasiveness. For example, one of the surfaces may have a coarse abrasive material while the other surface may be comprised of a finer abrasive material so that the user can initially shape the fingernail with the coarser material and finish the shaping of the fingernail with the finer abrasive material. An even finer abrasive can be used to buff or polish the fingernail.

The abrasive surface of the filing sleeve 14 itself, can be provided in the form of a strip that is affixed to the exterior surface of the filing sleeve 14 by means of an adhesive or can be molded or pressed into the external plastic or other material of the filing sleeve 14 and thus embedded into that external surface. As a further embodiment, the strip of abrasive material may be separately provided and slipped into a special formed external slotted surface on the external surface thereof, and then further affixed thereto by an adhesive.

The exterior surface of main body 12 of the writing instrument 10 may be smooth. In this embodiment, the filing sleeve 18 may be permanently installed.

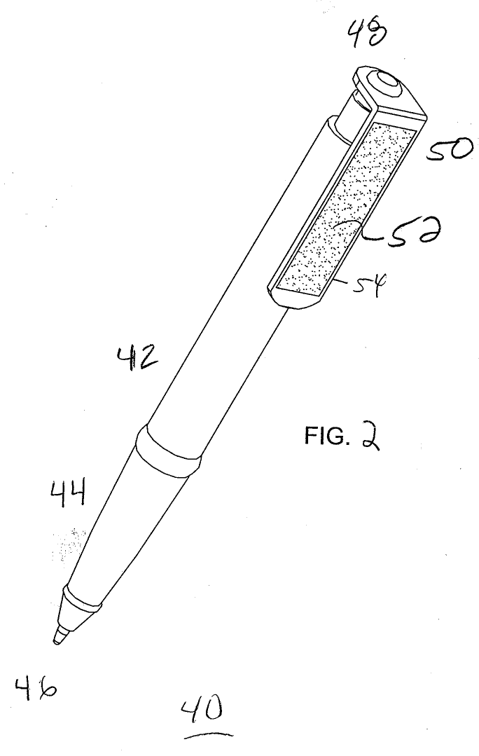

In another embodiment of the present invention, FIG. 2 shows a writing instrument 40 provided with a main body 42, a plunging mechanism 48, which when operated, provides an extension and retraction system for positioning a writing point in either a first position where the writing point 46 extends beyond the distal end 44 of the writing instrument 40 or in a second position where the writing point is retained within the housing of the writing instrument 40.

The plunging mechanism 48 may also include a clip 50 as described above. Additionally, this embodiment may comprise an abrasive surface 52 on the exterior surface thereof, there may be a non-abrasive surface 54 located separate from the abrasive surface 54 for the convenience in using the writing instrument 40 for the shaping of the fingernails.

While illustrative embodiments of the invention have been described above, it is, of course, understood that various modifications will be apparent to those of ordinary skill in the art. Such modifications are within the spirit and scope of the invention, which is limited and defined only by the appended claims.

What is claimed is:

1. A writing instrument comprising:
a main body having an external surface,
wherein said main body comprises:
a proximal end;
a distal end having a writing point;
a portion towards the distal end that a user grips when using the writing instrument for writing; and
a portion towards the proximal end comprising; and
a plunging mechanism comprising an abrasive surface used for nail filing.

2. The writing instrument of claim 1 wherein the abrasive surface used for nail filing is attached to the plunging member.

3. The writing instrument of claim 1 wherein the abrasive surface used for nail filing is fitted in a recessed portion of the plunging member.

4. The writing instrument of claim 1 wherein the abrasive surface used for nail filing comprises one or more grades of abrasiveness.

5. The writing instrument of claim 1 wherein the portion towards the proximal end further comprises a clip.

6. The writing instrument of claim 5 wherein the abrasive surface used for nail filing is fitted in a recess portion on the clip.

7. A method of making a writing instrument comprising the steps of:
providing a writing instrument having a main body having an external surface,
wherein said main body has a proximal end and a distal end having a writing point, a portion towards the distal end that a user grips when using the writing instrument for writing, and a portion towards the proximal end comprising a plunging member comprising an abrasive surface used for nail filing.

8. The method of making a writing instrument as defined in claim 7 wherein the abrasive surface used for nail filing is attached to the plunging member.

9. The method of making a writing instrument as defined in claim 7 wherein the abrasive surface used for nail filing is fitted in a recessed portion of the plunging member.

10. The method of making a writing instrument as defined in claim 7 wherein the abrasive surface used for nail filing comprises one or more grades of abrasiveness.

11. The method of making a writing instrument as defined in claim 7, wherein the plunging mechanism provided comprises as clip

12. The method of making a writing instrument as defined in claim 11 wherein the abrasive surface used for nail filing is fitted in a recess portion of the clip.

16. The method of making a writing instrument as defined in claim 7 wherein the clip is attached to the plunging member.
